(19) United States
(12) Patent Application Publication
(10) Pub. No.: US 2013/0303207 A1
(43) Pub. Date: Nov. 14, 2013

(54) SYSTEMS AND METHODS TO ACCESS SOCIAL NETWORKING SERVICES USING UNSTRUCTURED SUPPLEMENTARY SERVICE DATA (USSD) ON MOBILE DEVICES

(71) Applicant: U20PIA MOBILE PVT LTD, Haryana (IN)

(72) Inventors: Ankit Nautiyal, Gurgaon (IN); Sumesh Menon, Bangalore (IN)

(73) Assignee: U20PIA MOBILE PVT LTD, Haryana (IN)

(21) Appl. No.: 13/893,250

(22) Filed: May 13, 2013

Related U.S. Application Data
(60) Provisional application No. 61/646,690, filed on May 14, 2012.

(51) Int. Cl. H04W 4/14

(52) U.S. Cl. CPC H04W 4/14
USPC 455/466

(57) ABSTRACT

The embodiments herein relate to accessing internet based social networking services and, more particularly, to accessing internet based social networking services using unstructured supplementary service data (USSD) on mobile devices. Embodiments disclosed herein enable a user to access the social network using any GSM enabled phone, wherein the user need not have internet connections enabled on the phone.

### PRIORITY CLAIM

The present application is based on, and claims priority from, U.S. application No. 61/646,690, filed on 14 May 2012, the disclosure of which is hereby incorporated by reference herein.

### TECHNICAL FIELD

The embodiments herein relate to accessing internet based social networking services and, more particularly, to accessing internet based social networking services using unstructured supplementary service data (USSD) on mobile devices.

### BACKGROUND

Currently, social networks are popular with a large number of people having a presence on at least one social network. Without being restricted to accessing social networks using computers (desktops, laptops or any other form of computer), the user would like to access the social network at all points in time. The access may be in the form of the user receiving updates/messages from this social network and/or the user posting updates/messages to the social network.

Users may use their mobile devices to access the internet and hereby access the social networks. However, the mobile device has to be able to access the internet using a suitable means such as a GPRS/2G/3G/4G connection or any other suitable means. However, the mobile devices having such a capability are generally expensive and may not be accessible to the general public. Further, the data plans for accessing the internet provided by the mobile network operators may prove to be another costly factor.

### BRIEF DESCRIPTION OF THE FIGURES

The embodiments herein will be better understood from the following detailed description with reference to the drawings, in which:

FIG. 1 illustrates a communication network, according to embodiments as disclosed herein;

FIG. 2 depicts exemplary screenshots, according to embodiments as disclosed herein;

FIG. 3 is a flowchart depicting the process of a user registering with a social networking website, according to embodiments as disclosed herein;

FIG. 4 is a sequence diagram depicting the process of a user accessing a social networking website ;

FIG. 5 is a sequence diagram depicting the process, according to embodiments as disclosed herein; and

FIGS. 6 and 7 are exemplary network diagrams, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

A social networking service may be defined herein as an online service, platform and/or site that focus on building and maintaining social networks or social relationships among people. The “relationships” need not necessarily be genealogical; they can be of any kind, for example, share common interests and/or activities. A social network service comprises of a representation of each user (often a profile), his/her social links, and a variety of additional services, which permit the users to communicate, share and interact with other users in the social network. Most social network services are web-based and provide means for users to interact over the Internet, such as e-mail and instant messaging. Many of the social networks may also enable building of websites and applications that allow their users to access their networks using mobile devices. Examples of social networks are Facebook, LinkedIn, MySpace and so on.

USSD (Unstructured Supplementary Service Data) is a Global System for Mobile (GSM) communication technology that is used to send text between a mobile phone and an application program in the network such as prepaid roaming, mobile chatting, etc. USSD is capable of establishing a session. This means the handset and the USSD application can now have the technical equivalent of a dialogue. USSD Phase 2.0 is specified in the GSM 03.90 and supports both mobile-initiated as well as network-initiated operations (pull and push operations).

An Operator firewall is a set of related programs, located at a network gateway server that protects the resources of an operator network (Cellular Operator) from users from other networks. It gives selective access to the network to applications not on the operator network.

A billing server is a server that maintains the billing for subscribers. Other applications make calls to this server for billing.

A short message service center (SMSC) is a network element in the mobile telephone network which delivers SMS messages.

A proxy server is a server maintained outside of the Operator network. This server is used for routing the calls to the social networking servers.

The Short Message Peer-to-Peer (SMPP) protocol is a telecommunications industry protocol for exchanging SMS messages between SMS peer entities such as short message service centers and/or External Short Messaging Entities. It is often used to allow third parties (e.g. value-added service providers like news organizations) to submit messages, often in bulk.

Signaling System No. 7 (SS7) is a set of telephony signaling protocols which are used to set up most of the world's public switched telephone network telephone calls. The main purpose is to set up and tear down telephone calls. Other uses include number translation, local number portability, prepaid billing mechanisms, short message service (SMS), and a variety of other mass market services.

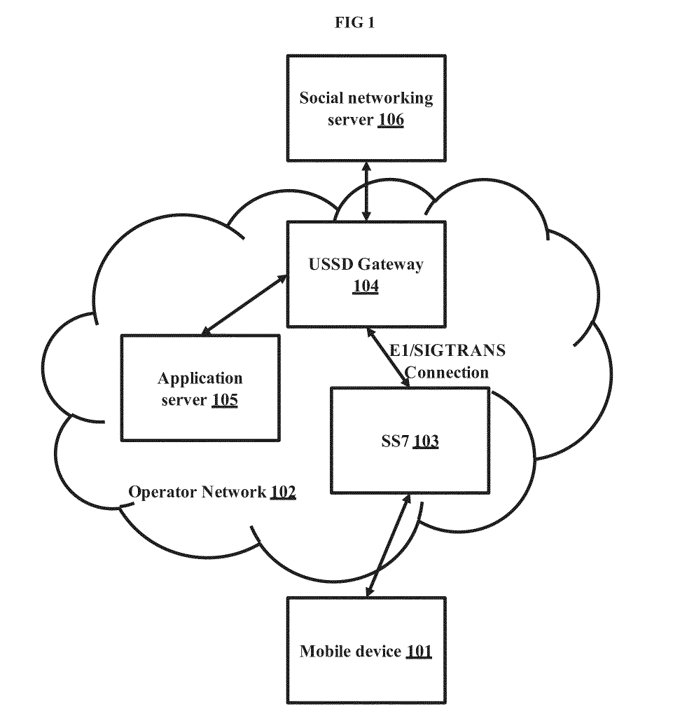

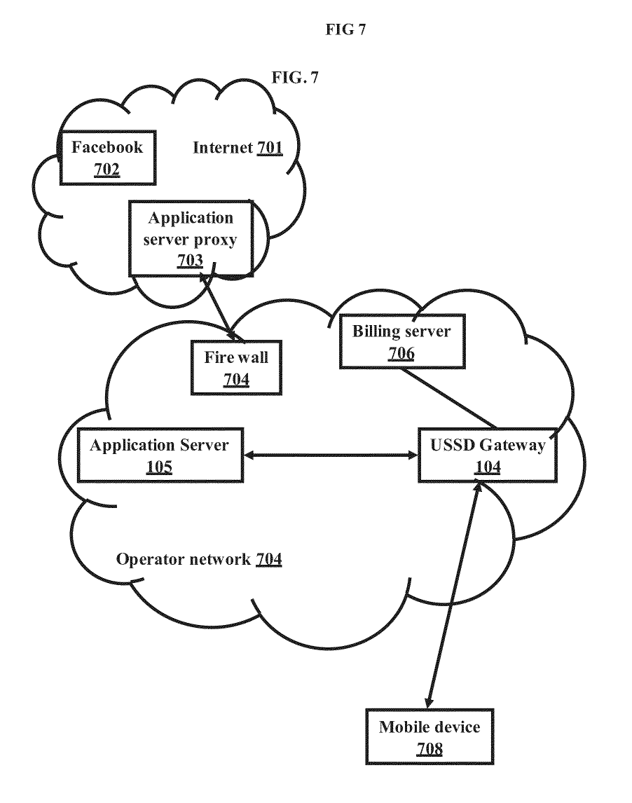

The embodiments herein disclose methods and systems for enabling access to internet based social networking services using menu based unstructured supplementary service data (USSD) on mobile devices. Referring now to the drawings, and more particularly to FIGS. 1 through 7, where similar reference characters denote corresponding features consistently throughout the figures, there are shown embodiments.

FIG. 1 illustrates a communication network, according to embodiments as disclosed herein. The communication network, as depicted, comprises of at least one mobile device 101, an operator network 102 and a social networking server 106. The mobile device 101 may be any device capable of accessing the operator network 102. Examples of the mobile device 101 may be mobile phones, tablets, PDAs and so on. The operator network 102 may be a wireless communication network capable of providing USSD services. The operator network 102 further comprises of a SS7 103, a USSD gateway 104 and an application server 105. In an embodiment herein, the application server 105 may reside outside the operator network 102.

A user of the mobile device 101 may initiate access of the social network by dialing a specific USSD code. The USSD code may vary with the service and/or the social network being accessed. The USSD code acts as a trigger. The mobile device invokes the use of USSD bearer and communicates with the USSD gateway 104, via the SS7 103 using SS7 signaling channels. On the USSD gateway 104 receiving a request, the USSD gateway 104 routes to the specific destination social network.

If the user desires to register for an account with a social network, the user sends a USSD code to the application server 105, wherein the USSD code sent by the user is the USSD code for account registration. The application server 105 sends a request to the mobile device 101 for details of the user, such as name of the user, the date of birth of the user, the gender of the user and any other required personal information. The mobile device 101 sends the requested information to the application server 105. The application server 105 contacts the social networking server 106 with the information provided by the mobile device 101. The social networking server 106 registers an account for the user using the provided information and sends a confirmation to the application server 105, which further informs the confirmation of the successful registration to the mobile device 101. The application server 105 provides the user with the menu for the social network, via the mobile device 101.

In another embodiment herein, the application server 105 fetches the most frequently contacted MSISDNs from the operator 102. The application server 105 may also fetch the MSISDNs using any other suitable criteria, such as MSISDNs dialed in the past one month, the MSISDNs which are most frequently dialed from the mobile device 101, the MSISDNs which most frequently call/instant message/SMS the mobile device 101 and so on. The application server 105 further contacts the user via the mobile device 101 asking for invites to the fetched MSISDNs. On receiving an approval from the user to send an invite to at least one MSISDN, the application server 105 sends an invite to the MSISDNs as indicated by the user.

The application server 105 authenticates the user by asking for the required credentials from the user over the SS7 signaling streams. After the user has been verified, the application server 105 receives a user access token from the social networking server 106, which is stored in the application server 105, with every subsequent request from this user being validated using the user access token. In another embodiment herein, the application server 105 may store the credentials of the user in a suitable encrypted format and every subsequent request from this user is validated using the stored credentials. In another embodiment herein, the application server 105 and the USSD gateways 104 may ask the user for his credentials, before every request.

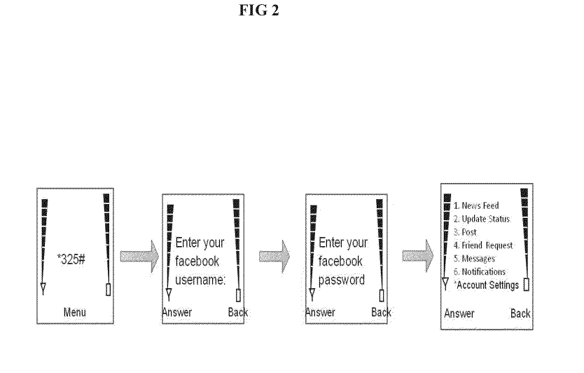

The application server 105 initiates a real time application session between the mobile device and the social networking server 106. The mobile device 101, then presents the user with a menu (as depicted in FIG. 2, wherein Facebook, layout of the menu, the USSD string and other items depicted are used as examples and should not construed as limiting the embodiments as disclosed herein), which depends on the social network that the user is accessing and may differ for each social network. The user may select a suitable option from the menu. The user may also type an option using an interface present on the mobile device 101. The session remains open over the radio connection until the USSD service is completed. The USSD service may be completed by the user terminating the application, the user entering an incorrect option from the menu, a time-out occurring or any other equivalent action.

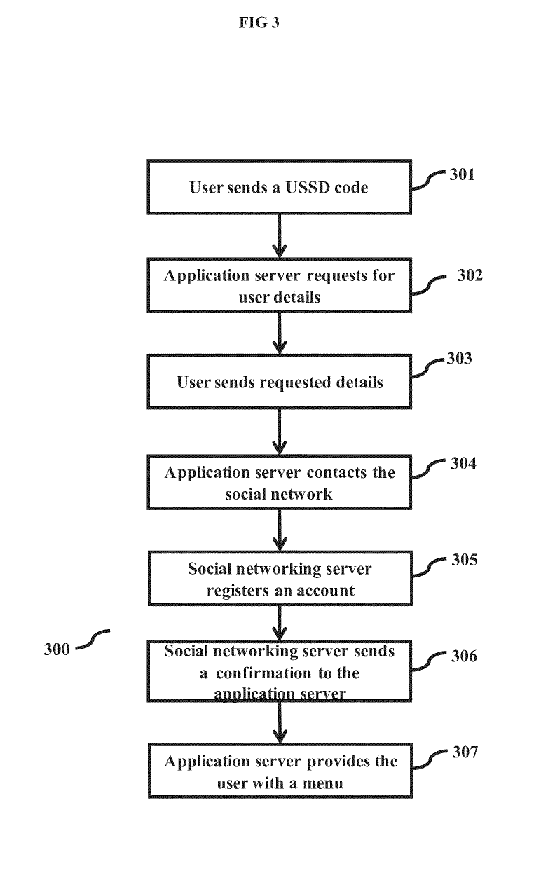

FIG. 3 is a flowchart depicting the process of a user registering with a social networking website, according to embodiments as disclosed herein. The mobile device 101 sends (301) an USSD request to the user. The mobile device 101 may send the request on the user of the mobile device 101 initiating access of the social network by dialing a specific USSD code. The application server 105 authenticates (302) the user by asking for the required credentials from the user over the SS7 signaling streams. Once the user sends (303) his credentials, the application server 105 authenticates (304) the user. If the user has been verified (305), the social networking server 106 creates a user access token and sends (307) the token to the application server 105. The application server 105 initiates (308) a real time application session between the mobile device and the social networking server 106. The various actions in method 300 may be performed in the order presented, in a different order or simultaneously. Further, in some embodiments, some actions listed in FIG. 3 may be omitted.

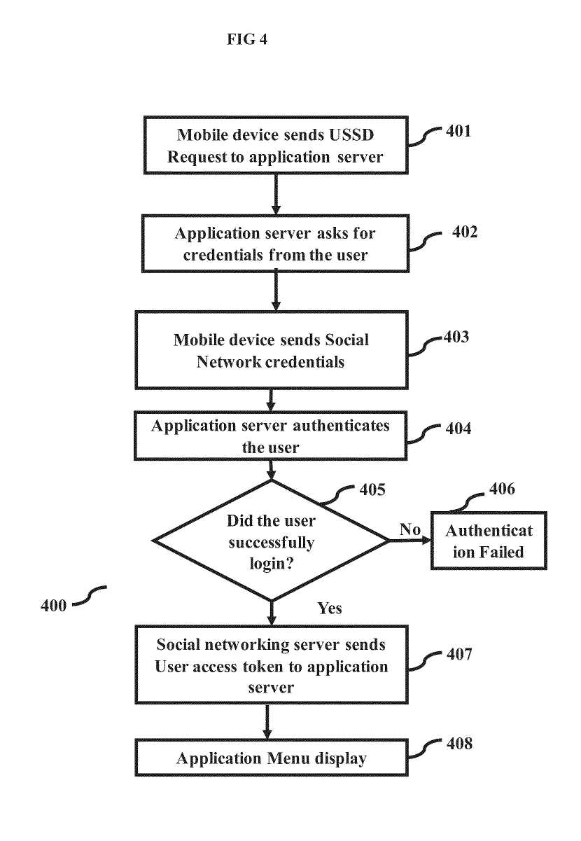

FIG. 4 is a sequence diagram depicting the process of a user accessing a social networking website, according to embodiments as disclosed herein. The mobile device 101 sends an USSD request to the user. The mobile device 101 may send the request on the user of the mobile device 101 initiating access of the social network by dialing a specific USSD code. The application server 105 authenticates the user by asking for the required credentials from the user over the SS7 signaling streams. Once the user sends his credentials, the application server 105 authenticates the user. If the user has been verified, the social networking server 106 creates a user access token and sends the token to the application server 105. The application server 105 initiates a real time application session between the mobile device and the social networking server 106. If the user is unable to be authenticated using the credentials supplied by the user, the social networking server 106 informs the user of the failure, via the application server 106.

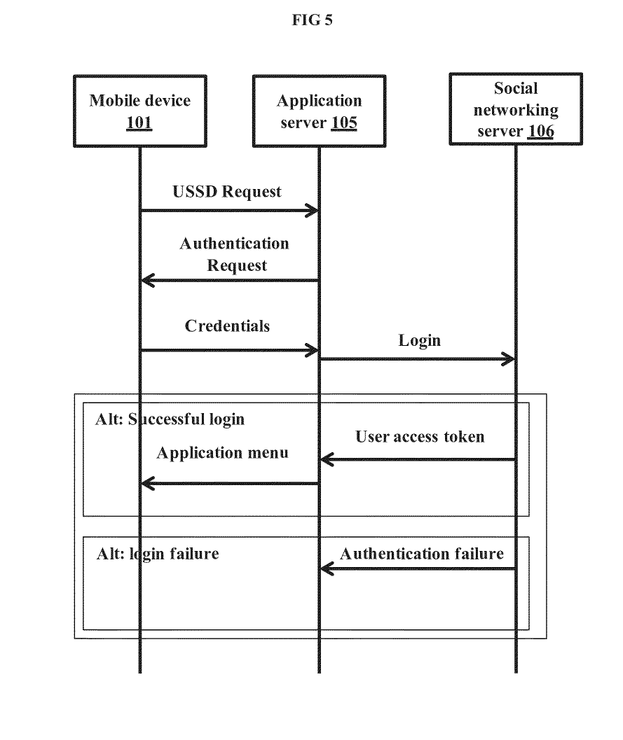

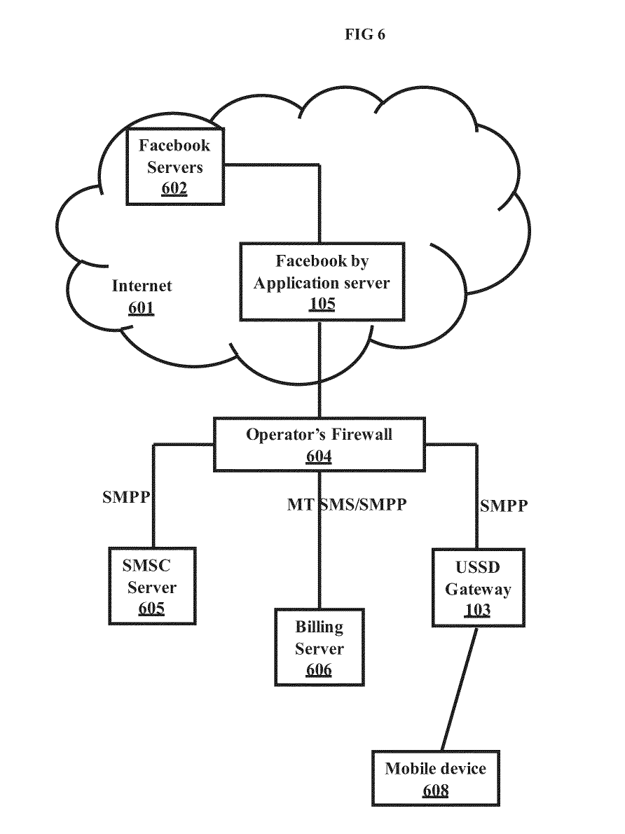

FIGS. 5 and 6 are exemplary network diagrams, according to embodiments as disclosed herein. FIGS. 5 and 6 use Facebook as an example of a social network.

In FIG. 5, the application server 105 sits outside the Operator network 102. The application server 105 connects to the USSD gateway 103 using a TCP/IP connection. The application server 105 also supports a dedicated VPN connection, if required by the operator. The operator needs to give access to the application server 105 requests through their firewall. The application server 105 connects to the billing server though a HTTP interface. The application server 105 also supports the UCIP and MTSMS based billing.

In FIG. 6, the application server 105 sits inside the Operator network 102. The application server 105 connects to the USSD gateway via a suitable internal network (which may be a Local Area Network (LAN)). All the communication between the application server 105 and the USSD gateway 103 may happen over SMPP protocol.

Embodiments disclosed herein enable Instant Messaging (popularly known as chatting) using USSD. Users may create direct dial codes (known as PINs) to connect to their friends. These PINs are USSD codes and each USSD code identifies a specific friend directly for User A. Consider an example wherein a User A using USSD messaging service and using PIN *XYZ#, sends a message to a Friend A, a USSD code of the form, *XYZ*A# or *XYZ&AB*D# will be generated for Friend A. User A can store this code in his Phone address book against Friend A's name. Next time this code can be directly used to send a message to friend A.

Embodiments herein enable reminders about events associated with the social network of the user to be sent to the user using a suitable means such as SMS, USSD and so on. The events may comprise of meetings, get-togethers, birthdays, anniversaries, public holidays and so on. The events may be present on the calendar of the user or a user associated with the user (and as indicated by the user). The user may also be provided the option of enabling or disabling this feature using the menu presented to the user.

Embodiments disclosed herein enable a user to access the social network using any GSM enabled phone, wherein the user need not have internet connections enabled on the phone.

The embodiments disclosed herein can be implemented through at least one software program running on at least one hardware device and performing network management functions to control the network elements. The network elements shown in FIGS. 1, 6 and 7 include blocks which can be at least one of a hardware device, or a combination of hardware device and software module.

The embodiment disclosed herein specifies a system for enabling access to internet based social networking services using menu based unstructured supplementary service data (USSD) on mobile devices. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A method for enabling a user to access a social network through a communication network using a mobile device, said method comprising
initiating access to said social network by said user by dialing a unstructured supplementary service data (USSD) code on said mobile device;
routing said USSD code to appropriate social network by said communication network, on receiving said USSD code;
initiating a session between said user and said social network by said communication network, on said social network authenticating said user; and
enabling at least one interaction between said user and said social network using said session by said communication network.

2. The method, as claimed in claim 1, wherein said method further comprises of enabling said user to create an account with said social network.

3. The method, as claimed in claim 2, wherein a phone number associated with said mobile device is used to identify said user.

4. The method, as claimed in claim 1, wherein said communication network identifies said social network based on said USSD code, wherein each social network has a unique USSD code.

5. The method, as claimed in claim 1, wherein said method further comprises of authenticating said user on a per session basis.

6. The method, as claimed in claim 1, wherein said method further comprises of authenticating said user on a per interaction basis.

7. The method, as claimed in claim 1, wherein SS7 signaling streams are used for authentication.

8. The method, as claimed in claim 1, wherein initiating said session between said user and said social network further comprises of
sending an access token by said social network to said communication network, on said social network authenticating said user; and
initiating an application on said mobile device by said communication network, on receiving said access token.

9. The method, as claimed in claim 8, wherein said application comprises a menu for enabling said at least one interaction.

10. The method, as claimed in claim 1, wherein said method further comprises of providing reminders to said user about events present in said social network using at least one of Short Messaging Service (SMS); or USSD.

11. The method, as claimed in claim 1, wherein said method further comprises of said user performing Instant Messaging using USSD.

12. The method, as claimed in claim 11, wherein said method further comprises of using a PIN for initiating an Instant Messaging session with a friend, wherein said PIN is associated with said friend.

13. A system for enabling a user to access a social network through a communication network using a mobile device, said system comprising
said mobile device configured for enabling said user to initiate access to said social network by dialing an unstructured supplementary service data (USSD) code;
said communication network configured for routing said USSD code to appropriate social network, on receiving said USSD code;
initiating a session between said user and said social network, on said social network authenticating said user; and
enabling at least one interaction between said user and said social network using said session.

14. The system, as claimed in claim 13, wherein said system is further configured for enabling said user to create an account with said social network.

15. The system, as claimed in claim 13, wherein said system is further configured for identifying said user using a phone number associated with said mobile.

16. The system, as claimed in claim 13, wherein said communication network is further configured for identifying said social network based on said USSD code, wherein each social network has a unique USSD code.

17. The system, as claimed in claim 13, wherein said system is further configured for authenticating said user on a per session basis.

18. The system, as claimed in claim 13, wherein said system is further configured for authenticating said user on a per interaction basis.

19. The system, as claimed in claim 13, wherein said system is further configured for using SS7 signaling streams for authentication.

20. The system, as claimed in claim 13, wherein said system is further configured for initiating said session between said user and said social network by
sending an access token by said social network to said communication network, on said social network authenticating said user; and
initiating an application on said mobile device by said communication network, on receiving said access token.

21. The system, as claimed in claim 13, wherein said system is further configured for providing reminders to said user about events present in said social network using at least one of Short Messaging Service (SMS); or USSD.

22. The system, as claimed in claim 13, wherein said system is further configured for enabling said user to perform Instant Messaging using USSD.

23. The system, as claimed in claim 22, wherein said system is further configured for using a PIN for initiating an Instant Messaging session with a friend, wherein said PIN is associated with said friend.
